(19) United States
(12) Patent Application Publication
(10) Pub. No.: US 2016/0256341 A1
(43) Pub. Date: Sep. 8, 2016

(54) Positioning Mat for Bedridden Patients

(71) Applicant: Debra Counts, Prescott, AZ (US)

(72) Inventor: Debra Counts, Prescott, AZ (US)

(21) Appl. No.: 15/041,263

(22) Filed: Feb. 11, 2016

Related U.S. Application Data
(60) Provisional application No. 62/127,427, filed on Mar. 3, 2015.

(51) Int. Cl. A61G 7/10; A61G 7/057

(52) U.S. Cl. CPC A61G 7/1026; A61G 7/057; A61G 7/1034

(57) ABSTRACT

A waterproof pad, a roller, two brackets, and a crank comprises a positioning device for bedridden patients. The roller is mounted between the two brackets, which are securely affixed to each side of a hospital bed frame, near the headboard. The waterproof pad is affixed to the roller with a clip. The crank is removably affixed at one end of the roller and is used to roll the waterproof pad, bearing the patient, toward the headboard. The crank may be affixed on either the left or the right side of the bed for easy use.

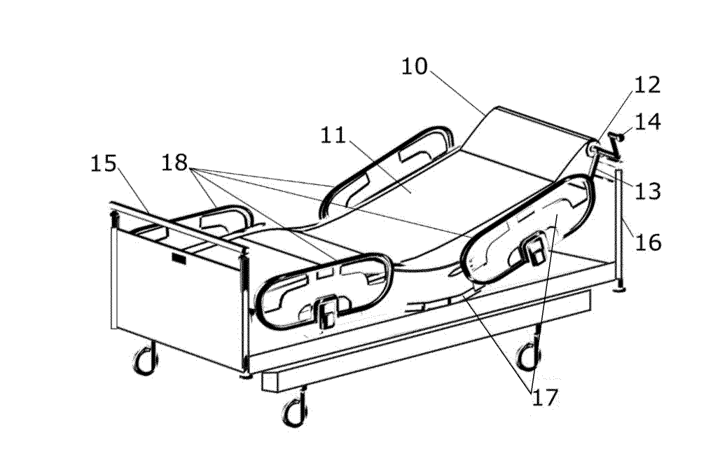

### CROSS-REFERENCE TO RELATED APPLICATIONS

This Application claims the benefit of U.S. Provisional Application No. 62/127,427, filed Mar. 3, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to hospital and nursing home equipment, and in particular to a positioning device for bedridden patients. One of the most difficult tasks facing nursing care employees is moving or positioning an adult patient, particularly an overweight patient, who cannot get out of bed. Patients frequently slide down to the foot of the bed, requiring repositioning. Also, it is well known that moving a patient periodically is beneficial in the prevention and treatment of such long term care issues as pneumonia and bedsores. Most employees in nursing homes and hospitals are female, and lack the upper body strength for this task. This has often resulted in various injuries to employees, particularly back injuries, and may also lead to a fall out of bed and injury for the patient.

A search of the prior art reveals various devices which have been developed to assist in the moving and positioning of a bedridden patient. None are closely related to the present invention, but several include features which resemble those of the present invention. Each has proven to be less than satisfactory in its own way.

Patient movement system, method, and apparatus, U.S. Pat. No. 7,062,804 (filed Aug. 27, 2003), provides a patient movement system comprised of a rotatable section coupled to a frame that moves in a horizontal plane. A hoist assembly is coupled to the rotatable section and spins relative to the rotatable section. The hoist assembly may be positioned by the rotatable section. The hoist assembly includes a first motor coupled to a first linearly moving pulley by a first linkage. The first linkage includes horizontal and vertical sections of travel, whereby the vertical sections of travel decrease when the horizontal sections of travel increase. The hoist assembly includes a second motor coupled to a second linearly moving pulley by a second linkage. The second linkage includes horizontal and vertical sections of travel, whereby the vertical sections of travel are decrease when the horizontal sections of travel increase. The hoist assembly may include additional pulleys to guides the first and second linkages.

Patient mover, U.S. Pat. No. 4,723,327 (filed Apr. 10, 1987), provides a device to transport and move bedridden patients easily and securely without potential injury to either the patient or the attendant. The device comprises a generally square sheet of flexible fabric material with an integral perimeter handle movable positioned within the fabric.

Device for moving a patient from his bed, U.S. Pat. No. 4,639,955 (priority Aug. 2, 1984), provides a device for moving a patient, of the type comprising: a support adapted to receive the body of the patient, a trolley comprising a motor actuating cables connected to the support for lifting the support loaded with the patient's body vertically then for translating it horizontally, at least one rail for translation over which said trolley moves. On the one hand said support, adapted to receive the patient's body, is comprised of a supple cloth in one piece, comprising at least three successive distinct parts: a first part adapted to receive and to maintain the patient's head, a second part adapted to receive and to maintain the patient's body, a third part adapted to receive and to maintain the patient's legs. On the other hand the trolley mobile over at least one rail comprises: a first pair of cables connected to the first part of the support, a second pair of cables connected to the third part of the support, a first, so-called lifting motor for controlling the movement of lifting and lowering of these two pairs of cables, a second, so-called translation motor for controlling the action of horizontal translation of this trolley.

Device for manipulating invalid bed patients, U.S. Pat. No. 4,536,903 (priority Jul. 1, 1983), provides a device for conveniently, gently and comfortably manipulating bed patients into various positions of rest, to aid in the prevention and/or treatment of pneumonia and to aid in the prevention and cure of bed sores in long term bed ridden patients, comprises a sheet of porous, “breathable” fabric of a size to span the width of the bed and to underlie the torso of the patient, hand grip means at the ends of the sheet adjacent the sides of the bed facilitating movement of the sheet into partially encircling relation to the patient's torso and rolling of the patient's body between the supine position (flat on the back) and positions on either of the patient's sides, at any desired degree of roll, and means for fastening the hand grip means to the bed for holding the patient's body at the desired degree of roll, thereby to mitigate accumulation of fluids in the patient's lungs and minimize the potential for pneumonia, to expose the patient's back to the air to mitigate the occurrence of bed sores, and to contribute to the patient's overall comfort and well being. Moreover, the device accommodates manipulation of the patient by one person without assistance, thereby to facilitate good care of the patient at home without professional aid, as well as in hospitals and professional nursing facilities.

Device for use in moving bed patients, U.S. Pat. No. 3,458,878 (priority Nov. 18, 1968), provides a device for use in moving a patient, including an elongated main strap fitted with a buckle at one end thereof, said one end being securable to the side rail of a hospital patient can then be moved. A harness is provided for fitting the body of patients who cannot elevate their knees, and is detachably mountable on the main strap, and by grasping both ends of the main strap it can also be used as a sling to carry a patient.

Patient turning and positioning device and method, U.S. Pat. No. 5,381,569 (priority Jan. 13, 1994), provides a device for moving a bed which includes a base member adapted to be supported by the patient support member interconnected to and supported by the base member. The patient support member is rotatable with respect to the base member, to enable movement of a patient between a supine position and a sitting position.

Portable patient moving device, U.S. Pat. No. 6,282,734 (priority Aug. 24, 1999), provides a portable bed frame. A first and a second detachable bearing support is connected to the bed frame, and supports near the head end thereof a shaft for rotation. A plurality of straps have one end connected to the shaft, and extend along the length of the bed to a patient support. By rotating the shaft, it is possible to move a patient who has been placed on the patient support longitudinally on the bed frame. The entire device may be conveniently detached from the bed frame and moved to another bed frame as necessary.

The present invention has been developed for the purpose of addressing and resolving the disadvantages of the prior art inventions. A positioning device for bedridden patients, providing a waterproof pad, roller, and crank which enable employees to more easily pull a patient toward the headboard, would resolve this problem.

### SUMMARY OF THE INVENTION

Accordingly, the invention is directed to a positioning device for bedridden patients. The device is comprised of a waterproof pad, a roller, two brackets, and a crank. The roller is mounted between the two brackets, which are securely affixed to each side of a hospital bed frame, near the headboard. The waterproof pad is affixed to the roller with a clip. The crank is removably affixed at one end of the roller and is used to roll the waterproof pad, bearing the patient, toward the headboard. The crank may be affixed on either the left or the right side of the bed for easy use.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

The FIGURE shows a side perspective view of a hospital bed with the first exemplary embodiment installed, displaying the device 10, the waterproof pad 11, the roller 12, the brackets 13, the crank 14, the bed 15, the headboard 16, the frame 17, and the rails 18.

### DETAILED DESCRIPTION OF THE INVENTION

Referring now to the invention in more detail, the invention is directed to a positioning device 10 for bedridden patients.

It is to be understood that while the invention is intended for use in certain circumstances in hospitals, nursing homes, and other long term care facilities, these are not intended as limitations, but as exemplary circumstances. With suitable modifications or with no modifications at all, the invention may be used in any situation wherein the user seeks to safely move a heavy object laterally.

The first exemplary embodiment is comprised of a positioning device 10 which is secured to the frame 17 of a hospital bed 15 near the headboard 16, with a pair of brackets 13. A roller 12 is mounted between the brackets 13, extending across the entire width of the bed 15. A waterproof pad 11, which is preferably 10 to 12 feet in length, extends across the entire width of the bed, and is secured to the roller 12 at one end with a clip and extends beyond the end of the bed opposite the headboard.

A crank 14 is removably affixed at one end of the roller 12 and is used to roll the pad 11, bearing the patient, toward the headboard 16. The crank 14 may be affixed on either the left or the right side of the bed 15 for easy use. Preferably, the diameter of the roller 12 and the length of the crank 14 are such that a 400-pound patient may be slowly moved by turning the crank 14 with one hand, even when the head of the bed 15 is elevated. An alternate embodiment, providing an electric motor to turn the roller 12, is contemplated.

To use the first exemplary embodiment, the user ensures that the patient is laying on the mat 11 and affixes the crank 14 to the desired end of the roller 12. The user then raises the rails 18 of the bed 15, and turns the crank 14 to relocate the patient in the desired position.

The pad 11 is preferably manufactured from flexible, durable material which provides a padded quality and is sturdy and waterproof, such as rubberized canvas surrounding a foam rubber core. The roller 12, brackets 13, and crank 14 are preferably manufactured from rigid, durable materials with significant structural strength, such as steel, aluminum alloy, and wood.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A positioning device, comprising a pair of brackets; a bed frame having a headboard, a left side, and a right side; said pair of brackets being mounted to the left side and the right side of said bedframe near the headboard; a roller; said roller being mounted between said pair of brackets; a pad; said pad being attached directly to said roller at one end; and said roller being configured to rotate such that said pad rolls around the circumference of said roller.

2. The positioning device of claim 1, wherein said pad is waterproof.

3. The positioning device of claim 1, wherein said pad extends across the entire width of the bedframe.

4. The positioning device of claim 1, wherein said pad extends from said roller beyond a bottom edge of the bedframe opposite the headboard.

5. The positioning device of claim 4, wherein said pad extends from said roller beyond a bottom edge of the bedframe opposite the headboard.

6. The positioning device of claim 1, wherein said pad is attached to said roller via a clip.

7. The positioning device of claim 3, wherein said pad is attached to said roller via a clip.

8. The positioning device of claim 4, wherein said pad is attached to said roller via a clip.

9. The positioning device of claim 5, wherein said pad is attached to said roller via a clip.

10. The positioning device of claim 1, further comprising a crank; said crank being removably affixed to one end of said roller; said crank being configured to rotate said roller such that said pad rolls around the circumference of said roller, moving towards the headboard.

11. The positioning device of claim 10, wherein said pad extends from said roller beyond a bottom edge of the bedframe opposite the headboard.

12. The positioning device of claim 10, wherein said pad is attached to said roller via a clip.

13. The positioning device of claim 11, wherein said pad is attached to said roller via a clip.

14. The positioning device of claim 10, wherein said crank may be affixed on either the left side or the right side of the roller.

15. The positioning device of claim 1, further comprising an electric motor; said electric motor being affixed to one end of said roller; said electric motor being configured to rotate said roller such that said pad rolls around the circumference of said roller, moving towards the headboard.

16. The positioning device of claim 15, wherein said pad extends from said roller beyond a bottom edge of the bedframe opposite the headboard.

17. The positioning device of claim 15, wherein said pad is attached to said roller via a clip.

18. The positioning device of claim 16, wherein said pad is attached to said roller via a clip.
